(19) United States
(12) Patent Application Publication
(10) Pub. No.: US 2026/0284887 A1
(43) Pub. Date: Sep. 24, 2026

(54) SYSTEM AND METHOD FOR INSTALLING VEHICLE COMPONENT INTO VEHICLE

(71) Applicant: Ford Global Technologies, LLC, Dearborn, MI (US)

(72) Inventors: Jon Arthur Zimmerman, Ferndale, MI (US); John Randolf Vincent, Livonia, MI (US); Kurt Michael Lundeen, Novi, MI (US)

(73) Assignee: Ford Global Technologies, LLC, Dearborn, MI (US)

(21) Appl. No.: 19/084,167

(22) Filed: Mar. 19, 2025

(51) Int. Cl. B25J 9/16; B62D 65/02

(52) U.S. Cl. CPC B25J 9/1687; B25J 9/1682; B62D 65/02

(57) ABSTRACT

A system for installing a vehicle component into a vehicle. The system includes a robot and a controller. The controller is in communication with the robot. The controller is configured to instruct the robot to grasp the vehicle component and move the vehicle component to a structure of an alignment fixture, instruct one of the structure and the robot to move one of an attachment feature of the vehicle component and a body of the vehicle component relative to the other of the attachment feature of the vehicle component and the body of the vehicle component, instruct the robot to move the vehicle component from the structure to the vehicle, and instruct the robot to insert the attachment feature of the vehicle component into an opening in a body of the vehicle until the vehicle component is secured to the body of the vehicle.

### FIELD

The present disclosure relates to a system and method for installing a vehicle component into a vehicle.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts such as wire harnesses, for example, may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure provides a system for installing a vehicle component into a vehicle. The system includes at least one robot and a controller. The controller is in communication with the robot. The controller is configured to instruct the robot to grasp the vehicle component and move the vehicle component to a structure of an alignment fixture, instruct one of the structure and the robot to move one of an attachment feature of the vehicle component and a body of the vehicle component relative to the other of the attachment feature of the vehicle component and the body of the vehicle component, instruct the robot to move the vehicle component from the structure to the vehicle, and instruct the robot to insert the attachment feature of the vehicle component into an opening in a body of the vehicle until the vehicle component is secured to the body of the vehicle.

In variations of the system of the above paragraph, which can be implemented individually or in any combination: the controller is configured to instruct the robot to move the one of the attachment feature of the vehicle component and the body of the vehicle component relative to the other of the attachment feature of the vehicle component and the body of the vehicle component; the controller is configured to instruct the robot to couple the vehicle component to the structure of the alignment fixture before moving the one of the attachment feature and the body relative to the other of the attachment feature and the body; coupling the vehicle component to the structure comprises inserting the attachment feature into a slot of the structure of the alignment fixture; the controller is configured to instruct the structure to move the one of the attachment feature of the vehicle component and the body of the vehicle component relative to the other of the attachment feature of the vehicle component and the body of the vehicle component; the robot supports the vehicle component as the structure moves the one of the attachment feature and the body relative to the other of the attachment feature and the body; the structure comprises a gripper assembly including a pair of opposed grippers; the system further includes the vehicle component, the vehicle component comprising a first electrical feature that is automatically electrically coupled to a second electrical feature of the vehicle when the vehicle component is secured to the vehicle; the first electrical feature comprises pogo pins; the attachment feature includes an attachment structure, the attachment structure secures the attachment feature to the body of the vehicle via a snap fit; and the vehicle component is a sun visor.

In another form, the present disclosure provides a system for installing a vehicle component into a vehicle. The system includes a first robot, a second robot and a controller. The controller is in communication with the first robot and the second robot. The controller configured to: instruct the first robot to grasp the vehicle component and move the vehicle component to a structure of an alignment fixture, instruct one of the structure and the first robot to move one of an attachment feature of the vehicle component and a body of the vehicle component relative to the other of the attachment feature of the vehicle component and the body of the vehicle component, instruct the second robot to move the vehicle component from the structure to a vehicle, and instruct the second robot to insert the attachment feature of the vehicle component into an opening in a body of the vehicle until the vehicle component is secured to the body of the vehicle.

In variations of the system of the above paragraph, which can be implemented individually or in any combination: the controller is configured to instruct the first robot to move the one of the attachment feature of the vehicle component and the body of the vehicle component relative to the other of the attachment feature of the vehicle component and the body of the vehicle component; the controller is configured to instruct the first robot to couple the vehicle component to the structure of the alignment fixture before moving the one of the attachment feature and the body relative to the other of the attachment feature and the body; the controller is configured to instruct the structure to move the one of the attachment feature of the vehicle component and the body of the vehicle component relative to the other of the attachment feature of the vehicle component and the body of the vehicle component; the system further includes the vehicle component, the vehicle component includes a first electrical feature that is automatically electrically coupled to a second electrical feature of the vehicle when the vehicle component is secured to the vehicle; the first electrical feature comprises pogo pins; the attachment feature includes an attachment structure, the attachment structure secures the attachment feature to the body of the vehicle via a snap fit; and the vehicle component is a sun visor.

In yet another form, the present disclosure provides a system for installing a vehicle component into a vehicle. The system includes a first robot, a second robot and a controller. The controller is in communication with the first robot and the second robot. The controller configured to: instruct the first robot to grasp the vehicle component and move the vehicle component to a first structure of an alignment fixture, instruct the first structure to move an attachment feature of the vehicle component relative to a body of the vehicle component, instruct the first robot to grasp the vehicle component and move the vehicle component from the first structure to a second structure of the alignment fixture, instruct the first robot to move the body of the vehicle component relative to the attachment feature of the vehicle component at the second structure, instruct the second robot to move the vehicle component from the second structure to a vehicle, and instruct the second robot to insert the attachment feature of the vehicle component into an opening in a body of the vehicle until the vehicle component is secured to the body of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a system for handling components of a vehicle according to the principles of the present disclosure;

FIG. 1B is a perspective view of one of the components secured to a vehicle according to the principles of the present disclosure;

FIG. 2A is a perspective view of a first structure of the fixture of the system of FIG. 1A with the structure being moved toward a closed position;

FIG. 2B is a perspective view of the first structure of the fixture of the system of FIG. 1A with the structure in a closed position;

FIG. 3 is a perspective view of a second structure of the fixture of the system of FIG. 1A with the vehicle component being inserted into the second structure;

FIG. 4 is a perspective view of the second structure of the fixture of the system of FIG. 1A with the vehicle component being in a first position;

FIG. 5 is a perspective view of the second structure of the fixture of the system of FIG. 1A with the vehicle component being in a second position;

FIG. 6 is a perspective view of the system of FIG. 1A showing a respective vehicle component being installed into the vehicle;

FIG. 7A is an enlarged close-up view of an area of the vehicle including an electrical feature;

FIG. 7B is a perspective view of an attachment feature of the vehicle component;

FIG. 8 is a perspective view of a portion of the component installed into the vehicle;

FIG. 9 is a schematic block diagram showing components of the system of FIGS. 1A and 1B in accordance with the teachings of the present disclosure; and

FIG. 10 is a flowchart depicting an algorithm for handling components of the system of FIGS. 1A and 1B in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

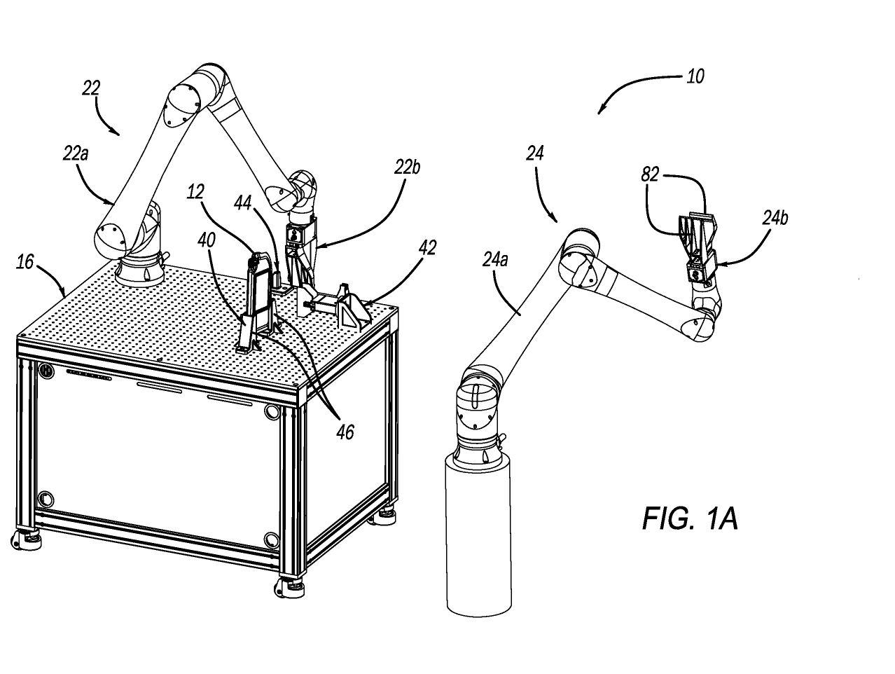

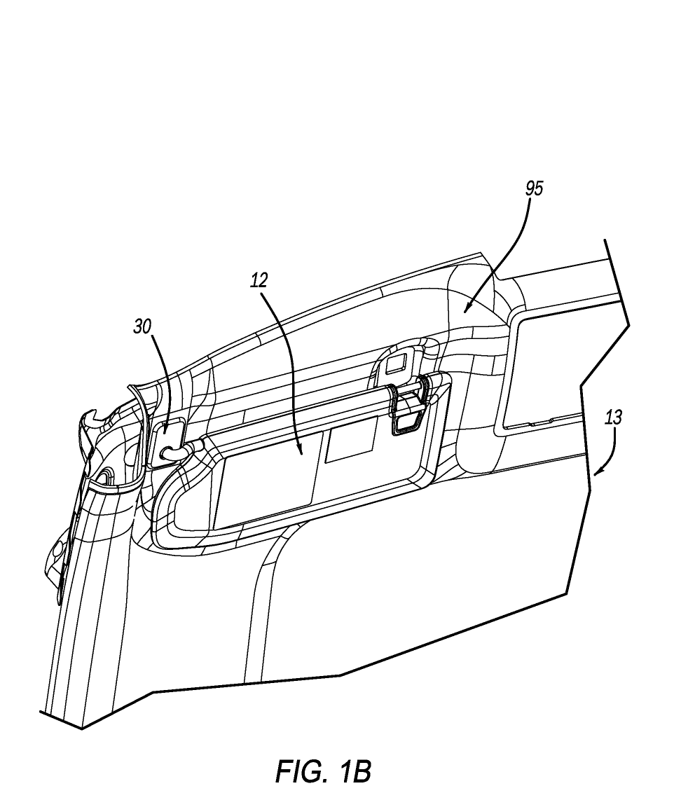

With reference to FIGS. 1A and 1B, a system 10 (FIG. 1A) for handling one or more vehicle components 12 (FIG. 1B) is illustrated. The handling of the vehicle components 12 may include retrieving the vehicle components 12 from a part support (e.g., a dunnage rack), placing the vehicle components 12 onto a workstation or alignment fixture 16, manipulating parts of the vehicle components 12 on the workstation 16, and/or installing the vehicle components 12 into a vehicle 13. The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 include a sun visor or a shield. The system 10 of the present disclosure provides for the adaptation of vehicle components 12 to better support automation.

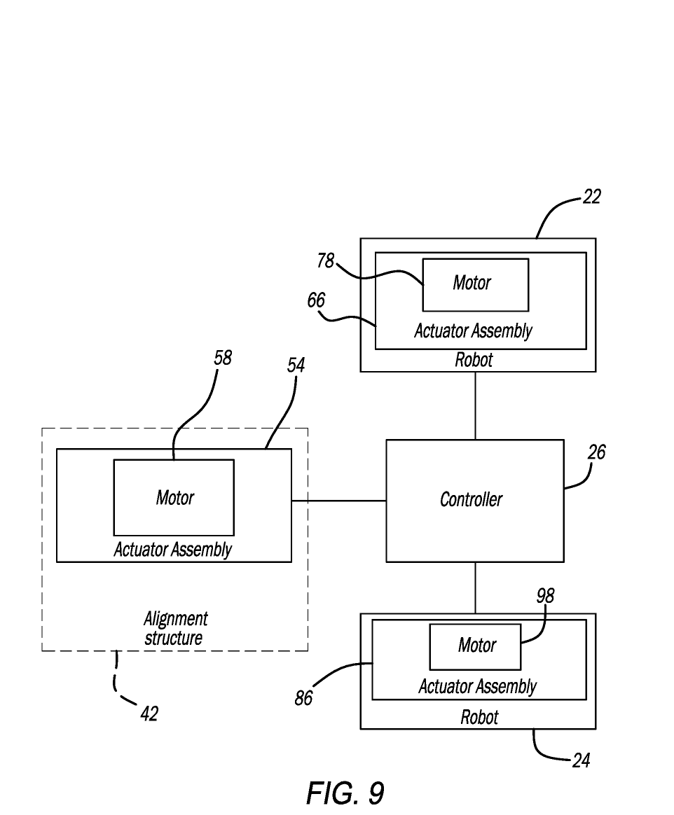

The system 10 may include the vehicle components 12 (only one shown in the figures), the alignment fixture 16, one or more robots 22, 24 and a controller 26 (FIG. 9). Each vehicle component 12 may be moved to the fixture 16 from the part support (not shown). Each vehicle component 12 includes a body or base 28 and an attachment feature 30. The body 28 may be made of a rigid material (e.g., metal or plastic) and includes a reflector portion (e.g., a mirror) that is selectively covered by a cover member. In some forms, the body 28 may also include a light source (e.g., light emitting diodes) at least partially surrounding the reflector portion of the body 28.

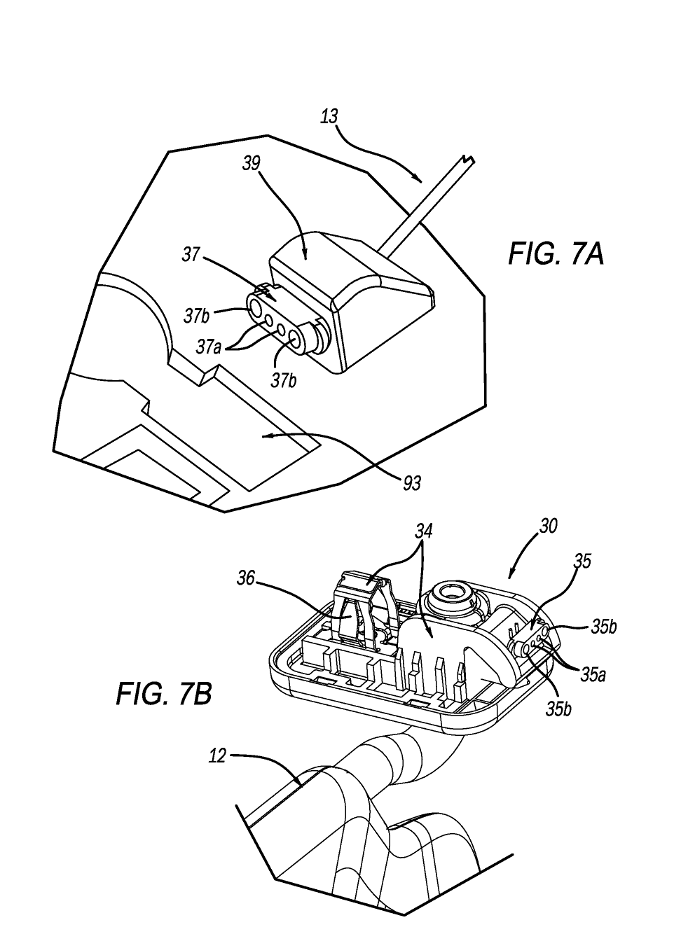

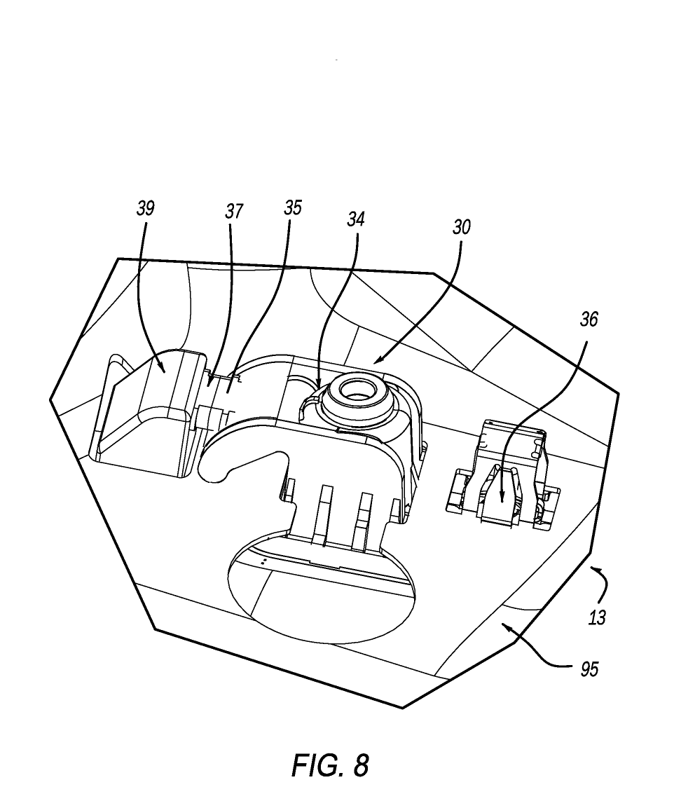

The attachment feature 30 is movable (e.g., pivotable) relative to the body 28 and is configured to be secured to the vehicle 13 (e.g., to a body 95 of the vehicle 13). In this way, the body 28 of the vehicle component 12 is movable relative to the vehicle 13 when the attachment feature 30 is secured to the vehicle 13. With reference to FIGS. 7A, 7B and 8, the attachment feature 30 includes an attachment structure 34 and an electrical feature 35. The attachment structure 34 facilitates securement of the vehicle component 12 to the vehicle 13. In one form, the attachment structure 34 comprises a biasing members 36 (e.g., clips) that snap into place on the vehicle 13, thereby creating a snap fit connection with the vehicle 13. In other forms, the attachment structure 34 may include mechanical fasteners, magnets, or any other suitable structure to facilitate attachment to the vehicle 13. The electrical feature 35 is configured to be electrically coupled to an electrical feature 37 of a wire harness 39 of the vehicle 13, thereby powering the light source (not shown) of the vehicle component 12. In the example illustrated, the electrical features 35, 37 include pogo pins 35a, 37a, respectively, that create electrical connection when connected. The electrical features 35, 37 also include magnets 35b, 37b, respectively, that are attracted to each other, thereby mechanically coupling the electrical features 35, 37 to each other. The electrical features 35, 37 are mechanically and electrically coupled to each other with little to no human intervention when the attachment feature 30 is secured to the vehicle 13. In some forms, the electrical features may include electrical terminals (not shown) that are configured to mate with each other.

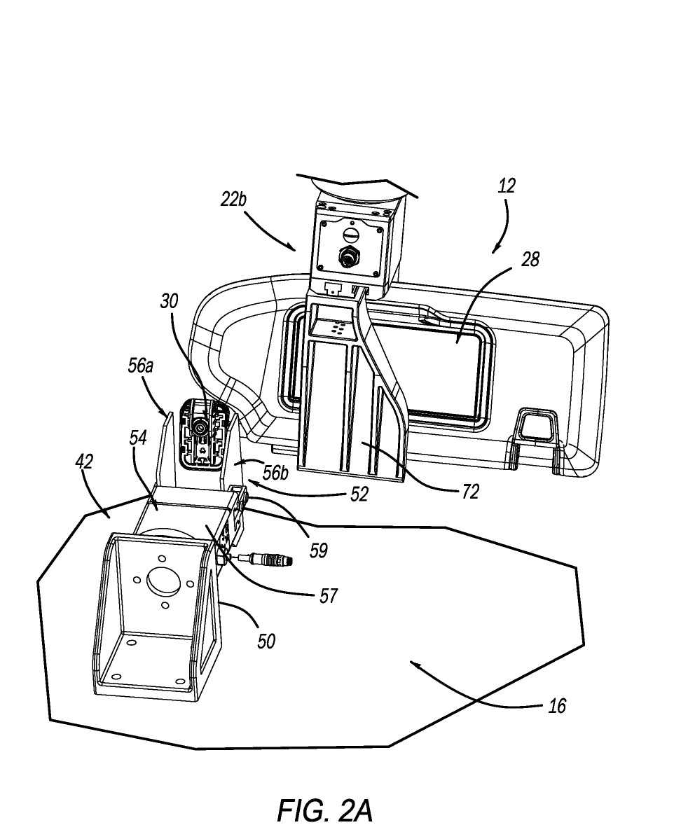

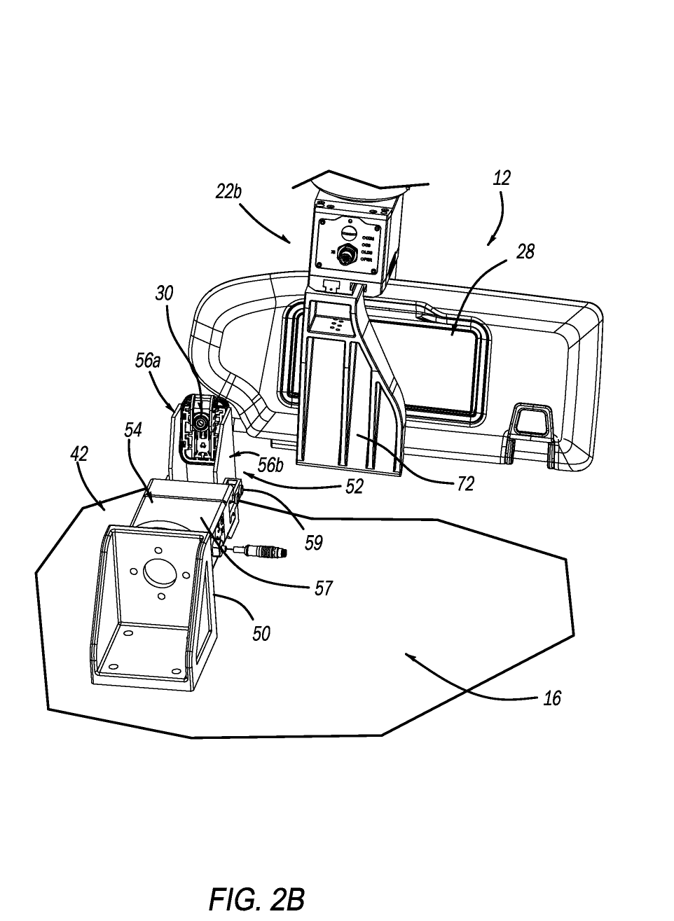

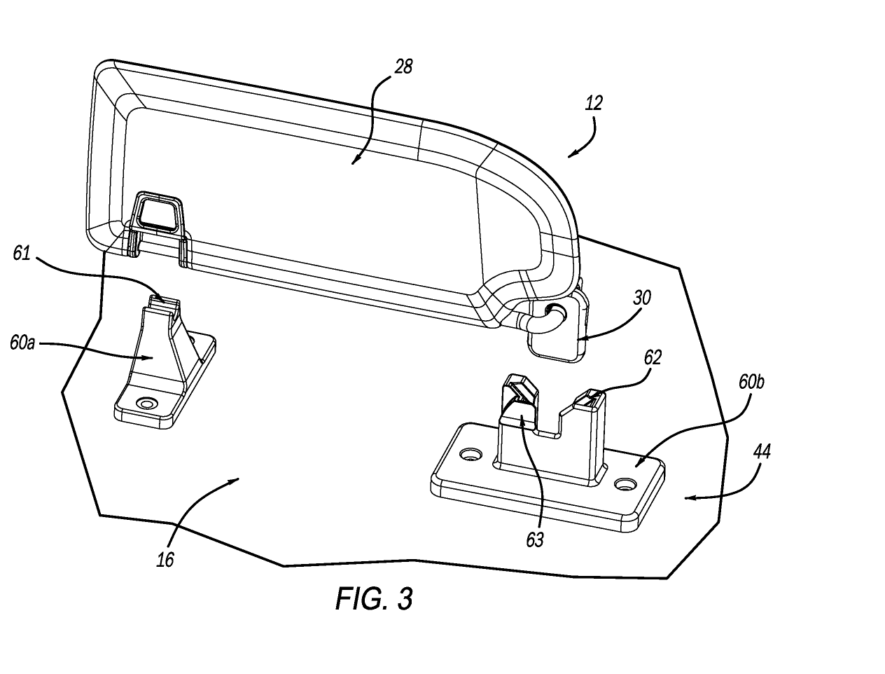

With reference to FIGS. 1A, 2A, 2B, and 3, the fixture 16 includes a support structure 40 (FIG. 1A), a first alignment structure 42 (FIGS. 1A, 2A, and 2B) and a second alignment structure 44 (FIGS. 1A and 3). In the example illustrated, the support structure 40 is fixed to a surface of the fixture 16 and includes mounting members 46 that are aligned with each other and spaced apart from each other. Each mounting member 46 includes a slot extending at least partially along a length of the mounting member 46 and configured to receive a portion of the vehicle component 12. In this way, the vehicle component 12 may be supported by the support structure 40. In the example illustrated, the support structure 40 supports the vehicle component 12 such that it extends vertically relative to the surface of the fixture 16. In some forms, the support structure 40 may support the vehicle component 12 such that it extends horizontally relative to the surface of the fixture 16 without departing from the scope of the present disclosure.

With reference to FIGS. 2A and 2B, the first alignment structure 42 includes a mounting portion 50 and an alignment assembly 52. The mounting portion 50 is fixed to the surface of the fixture 16 and supports the alignment assembly 52. The alignment assembly 52 is secured to the mounting portion 50 and is configured to align the vehicle component 12 (e.g., align one of the body 28 and the attachment feature 30 to a predetermined position).

The alignment assembly 52 includes an actuator assembly 54 and opposed end plates 56a, 56b. The actuator assembly 54 includes a body 57, a motor 58 (FIG. 9), and a pair of movable members or arms 59. The body 57 is secured to the mounting portion 50. The motor 58 is associated with the body 57 (e.g., disposed within the body 57) and is in electrical communication with the controller 26. The controller 26 may be in communication with the motor 58 via, for example, an internet, Wi-Fi, Bluetooth®, Zigbee®, power-line carrier communication (PLCC), or cellular connection or any other wired or wireless communication protocol. The motor 58 is operable between an OFF mode and an ON mode. In one form, the motor 58 may be an electric motor such as a brushless drive motor. Each arm 59 is operatively connected to the motor 58 and is allowed to move in a transverse direction (i.e., transverse to a longitudinal direction of the body 57). For example, when the motor 58 is in the OFF mode, the arms 59 are inhibited from moving in the transverse direction. When the motor 58 is in the ON mode, the arms 59 are allowed to move in the transverse direction between an open state and a closed state.

Each end plate 56a, 56b is secured to a respective arm 59 and is movable in a transverse direction between a first or closed position (FIG. 2B) and a second or open position (FIG. 2A). Stated differently, each end plate 56a, 56b is secured to the respective arm 59 such that when the respective arm 59 is moved to a closed state, the end plate 56a, 56b is moved to the closed position, and when the respective arm is in an open state, the end plate 56a, 56b is in the open position. In this way, the end plates 56a, 56b are configured to align the vehicle component 12 to a predetermined position when moved from the open position to the closed position. In the example illustrated, the end plates 56a, 56b are configured to align the attachment feature 30 of the vehicle component 12 to a predetermined position when the end plates 56a, 56b are moved to the closed position. In the example illustrated, the predetermined position may be a position in which the attachment feature 30 is oriented vertically relative to the surface of the fixture 16 (the attachment feature 30 is parallel to a vertical axis that is perpendicular to the surface of the fixture 16). That is, the attachment feature 30 may not be vertical with respect to the surface of the fixture 16 when the robot 22 picks up the vehicle component 12 from the support structure 40. The end plates 56a, 56b facilitate alignment of the attachment feature 30 before the vehicle component 12 moves to the second alignment structure 44 or the vehicle 13. It should be understood that the endplates 56a, 56b may align the attachment feature 30 to other predetermined positions as desired. In some forms, the end plates 56a, 56b are configured to align the body 28 of the vehicle component 12 to a predetermined position when the end plates 56a, 56b are moved to the closed position. The end plates 56a, 56b may include openings, slots, grooves formed therein that may accommodate features of the attachment structure 30.

With reference to FIGS. 3-5, the second alignment structure 44 includes mounting portions 60a, 60b fixed to the surface of the fixture 16 and spaced apart from each other. The mounting portion 60a includes a groove 61 formed in an upper surface of the mounting portion 60a that is configured to receive and support a portion of the vehicle component 12. The mounting portion 60b includes a slot 62 formed therein that is configured to receive and support the attachment feature 30 of the vehicle component 12. The mounting portion 60b also includes a groove 63 formed in a lateral side thereof that is configured to receive and support a portion of the vehicle component 12. In this way, when the vehicle component 12 is received on and supported by the second alignment structure 44, one of the body 28 and the attachment feature 30 may be moved (pivoted or rotated) relative to the other of the body 28 and the attachment feature 30. In the example illustrated, the body 28 of the vehicle component 12 is rotated relative to the attachment feature 30. That is, the attachment feature 30 received in the slot 62 of the mounting portion 60b inhibits the attachment feature 30 from moving while the body 28 is rotated to a desired position, thereby further aligning the vehicle component 12 prior to installation into the vehicle 12.

The robot 22 includes a robot arm 22a and a robotic gripper structure 22b. The robot arm 22aincludes a plurality of segments connected to each other at joints, thereby allowing the robot 22 to have multiple degrees of freedom. The robot arm 22a is also secured to the surface of the fixture 16 at a first end. In some variations, the robot arm 22a includes an optional adapter (not shown) that is adapted to be secured to the fixture 16. In some forms, the robot 22 is separate from the fixture 16 and is partially or fully autonomous and is configured to autonomously move to the part support and/or fixture 16 as instructed by the controller 26. To autonomously move itself, the controller 26 is configured to control various movement systems of the robot 22 based on location data obtained from one or more sensors. In an example application, the movement systems may include propulsion systems, steering systems for controlling wheels, and the sensors for providing location data may include a GNSS sensor, an imaging sensor, a local position sensor, among others.

The robotic gripper structure 22b is secured to the robot arm 22a and is configured to grasp and move a respective vehicle component 12 from the part support to different locations along the fixture 16. The robotic gripper structure 22b includes an actuator assembly 66 and opposed arms 72. The actuator assembly 66 includes a body 74, a motor 78 (FIG. 9), and a pair of movable members or arms (not specifically shown). The body 74 is secured to the opposing second end of the robot arm 22a. The motor 78 is associated with the body 74 (e.g., disposed within the body 74) and is in electrical communication with a controller 26. The controller 26 may be in communication with the motor 78 via, for example, an internet, Wi-Fi, Bluetooth®, Zigbee®, power-line carrier communication (PLCC), or cellular connection or any other wired or wireless communication protocol. The motor 78 is operable between an OFF mode and an ON mode. In one form, the motor 78 may be an electric motor such as a brushless drive motor. Each arm is operatively connected to the motor 78 and is allowed to move in a transverse direction (i.e., transverse to a longitudinal direction of the body 74). For example, when the motor 78 is in the OFF mode, the arms are inhibited from moving in the transverse direction. When the motor 78 is in the ON mode, the arms are allowed to move in the transverse direction between an open state and a closed state.

Each end plate 72 is secured to a respective arm and is movable in a transverse direction between a first or closed position and a second or open position. Stated differently, each end plate 72 is secured to the respective arm such that when the respective arm is moved to the closed state, the end plate 72 is moved to the closed position, and when the respective arm is in the open state, the end plate 72 is in the open position. The end plates 72 may grasp the vehicle component 12 when moved to the closed positions such that the robot 22 may move the vehicle component 12 along different locations of the fixture 16 as will be described in more detail below. In the example illustrated, the end plates 72 are may of a plastic or rubber material. In this way, impairment to the vehicle component 12 is inhibited. In some forms, the end plates 72a may further include cushions to inhibit impairment to the vehicle components 12.

The robot 24 includes a robot arm 24a and a robotic gripper structure 24b. The robot arm 24a includes a plurality of segments connected to each other at joints, thereby allowing the robot 24 to have multiple degrees of freedom. In the example illustrated, the robot arm 24a is secured to a floor of the work environment. In some forms, the robot arm 24a may be secured to the surface of the fixture 16 at a first end. In other forms, the robot 24 is separate from the fixture 16 and is partially or fully autonomous and is configured to autonomously move to the part support, the fixture 16, and/or the vehicle 13 as instructed by the controller 26. To autonomously move itself, the controller 26 is configured to control various movement systems of the robot 24 based on location data obtained from one or more sensors. In an example application, the movement systems may include propulsion systems, steering systems for controlling wheels, and the sensors for providing location data may include a GNSS sensor, an imaging sensor, a local position sensor, among others.

The robotic gripper structure 24b is secured to the robot arm 24a and is configured to grasp and move a respective vehicle component 12 from the part support to the vehicle 13. The robotic gripper structure 24b includes an actuator assembly 86 and opposed arms 82a, 82b. The actuator assembly 86 includes a body, a motor 98 (FIG. 9), and a pair of movable members or arms (not specifically shown). The body is secured to the opposing second end of the robot arm 24a. The motor 98 is associated with the body (e.g., disposed within the body) and is in electrical communication with a controller 26. The controller 26 may be in communication with the motor 98 via, for example, an internet, Wi-Fi, Bluetooth®, Zigbee®, power-line carrier communication (PLCC), or cellular connection or any other wired or wireless communication protocol. The motor 98 is operable between an OFF mode and an ON mode. In one form, the motor 98 may be an electric motor such as a brushless drive motor. Each arm is operatively connected to the motor 98 and is allowed to move in a transverse direction (i.e., transverse to a longitudinal direction of the body). For example, when the motor 98 is in the OFF mode, the arms are inhibited from moving in the transverse direction. When the motor 98 is in the ON mode, the arms are allowed to move in the transverse direction between an open state and a closed state.

Each end plate 82 is secured to a respective arm and is movable in a transverse direction between a first or closed position and a second or open position. Stated differently, each end plate 82 is secured to the respective arm such that when the respective arm is moved to the closed state, the end plate 82 is moved to the closed position, and when the respective arm is in the open state, the end plate 82 is in the open position. The end plates 82 may grasp the vehicle component 12 when moved to the closed positions such that the robot 24 may move the vehicle component 12 along different locations of the fixture 16 as will be described in more detail below. In the example illustrated, the end plates 82 are may of a plastic or rubber material. In this way, impairment to the vehicle component 12 is inhibited. In some forms, the end plates 82 may further include cushions to inhibit impairment to the vehicle components 12.

With reference to FIG. 9, the controller 26 is in communication with the robots 22, 24 and the first alignment structure 42, and may monitor and control operations of the robots 22, 24 and the first alignment structure 42 based on data received. In one example, the controller 26 is in communication with the robots 22, 24 and the first alignment structure 42 using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

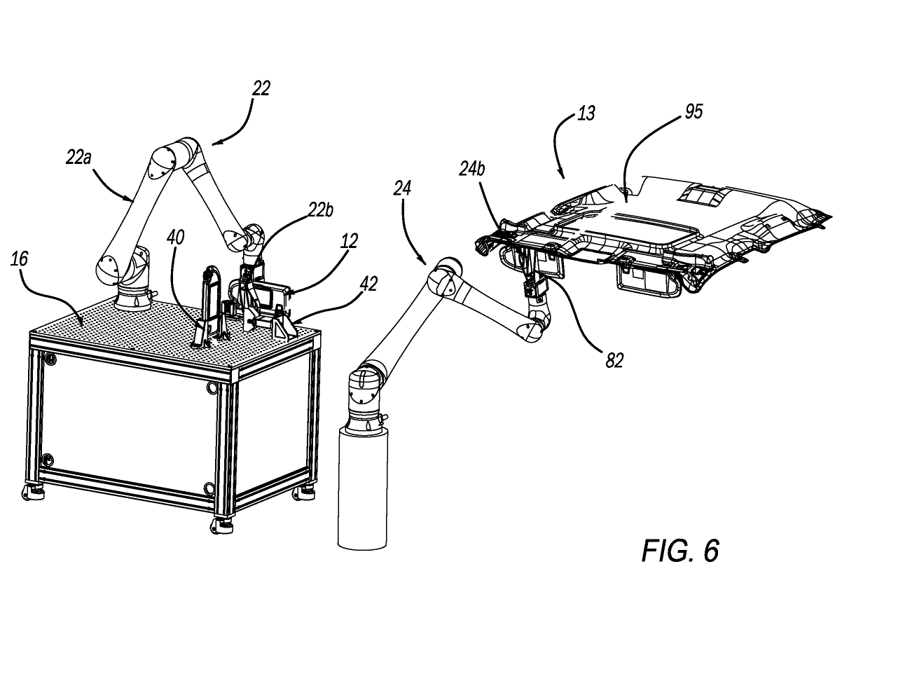

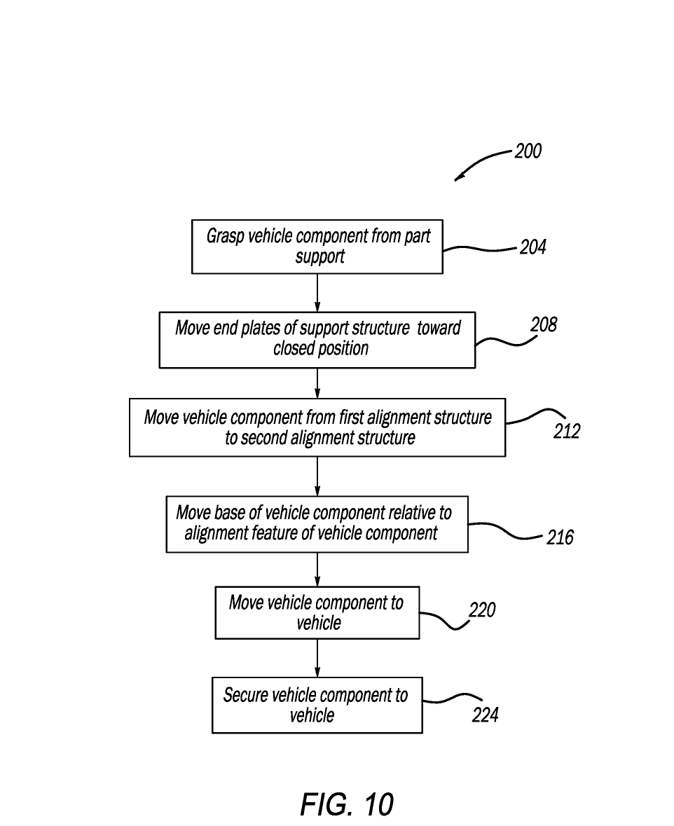

With reference to FIGS. 2A, 2B, 3-6, and 10, an example control algorithm 200 for moving the vehicle component 12 along the fixture 16 and installing the vehicle component 12 into vehicle 13 is illustrated. The processing may begin once the vehicle component 12 is moved from the part support (not shown) to the fixture 16. In some forms, the processing may begin once the vehicle component 12 is moved to the part support. At 204, the control algorithm, using the controller 26, instructs the robot 22 to grasp the body 28 of the vehicle component 12 from the support structure 40 and move the vehicle component 12 to the first alignment structure 42 such that the attachment feature 30 is positioned between the pair of opposed end plates 56a, 56b. At 208, the control algorithm, using the controller 26, instructs the motor 58 to move the opposed end plates 56a, 56b toward the closed position such that the attachment feature 30 is aligned (e.g., moved) to a predetermined position (FIGS. 2A and 2B). The vehicle component 12 is supported by the robot 22 when the opposed end plates 56a, 56b align the attachment feature 30 and the attachment feature 30 moves relative to the body 28.

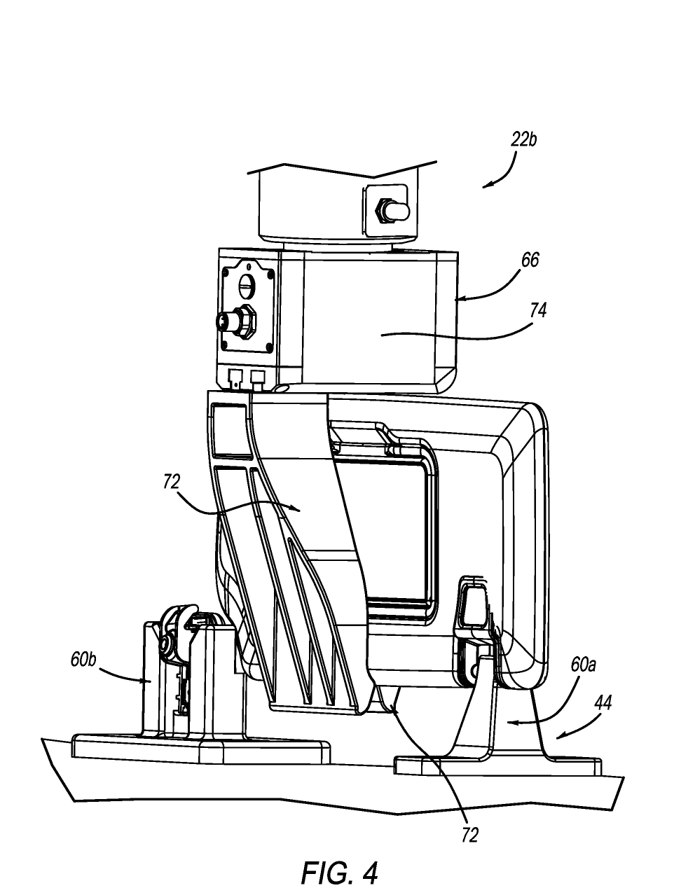

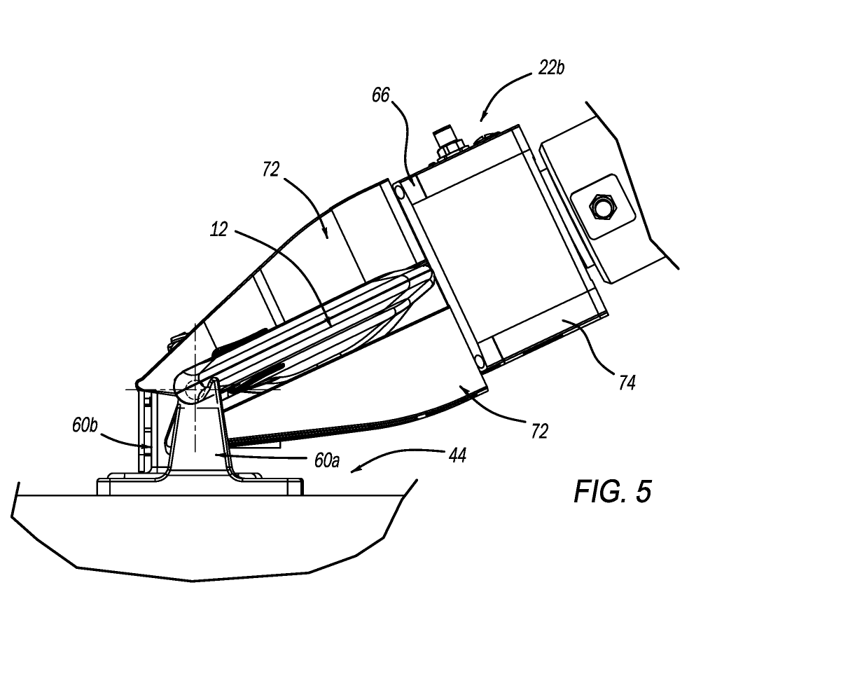

At 212, the control algorithm, using the controller 26, instructs the robot 22 to move the vehicle component from the first alignment structure 42 to the second alignment structure 44 and place the vehicle component 12 on the second alignment structure 44 such that it is at least partially supported by the second alignment structure 44 (FIG. 3). At 216, the control algorithm, using the controller 26, instructs the robot 22 to move the base 28 relative to the attachment feature 30 such that the base 28 is aligned to a predetermined position (FIGS. 4 and 5). At 220, the control algorithm, using the controller 26, instructs the second robot 24 to grasp the body 28 of the vehicle component 12 at the second alignment structure 44 and move the vehicle component 12 to the vehicle 13.

At 224, the control algorithm, using the controller 26, instructs the robot 24 to insert the attachment feature 30 of the vehicle component 12 into an opening or cutout 93 in the body 95 of the vehicle 13 until the vehicle component 12 is secured to the body 95 of the vehicle 13. In the example illustrated, the body 95 of the vehicle 13 is a roof (e.g., a headliner and/or sheet metal of the roof) and the cutout 93 is formed in a body. In some forms, the body 95 of the vehicle 13 may be a front pillar and the cutout 93 is formed in the front pillar. The robot 24 may move the vehicle component 12 in a predetermined path to guide the attachment feature 30 into the opening 93 in the body 95. Once the attachment feature 30 is fully inserted into the opening 93 of the body 95, the attachment feature 30 is secured to the body 95 by snap fit, for example. The electrical feature 35 of the attachment feature 30 is automatically electrically coupled to the electrical feature 37 of the vehicle 13. The electrical features 35, 37 also include magnets 35b, 37b, respectively, that are attracted to each other, thereby mechanically coupling the electrical features 35, 37 to each other once the attachment feature 30 is fully inserted into the opening 93 of the body 95.

It should be understood that the although the system 10 discloses the robots 22, 24 for moving the vehicle component 12 along the fixture 16 and installing the vehicle component 12 into vehicle 13, one of the robots 22, 24 may perform each step/operation as described above without departing from the scope of the present disclosure. Once the vehicle component 12 is connected to the vehicle 13, the robot 22 may move back to the starting position where it may attach to another vehicle component 12, thereby repeating the process again.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for installing a vehicle component into a vehicle, the system comprising:
at least one robot; and
a controller in communication with the at least one robot, the controller configured to:
instruct the at least one robot to grasp the vehicle component and move the vehicle component to a structure of an alignment fixture;
instruct one of the structure and the at least one robot to move one of an attachment feature of the vehicle component and a body of the vehicle component relative to the other of the attachment feature of the vehicle component and the body of the vehicle component;
instruct the at least one robot to move the vehicle component from the structure to the vehicle; and
instruct the at least one robot to insert the attachment feature of the vehicle component into an opening in a body of the vehicle until the vehicle component is secured to the body of the vehicle.

2. The system of claim 1, wherein the controller is configured to instruct the at least one robot to move the one of the attachment feature of the vehicle component and the body of the vehicle component relative to the other of the attachment feature of the vehicle component and the body of the vehicle component.

3. The system of claim 2, wherein the controller is configured to instruct the at least one robot to couple the vehicle component to the structure of the alignment fixture before moving the one of the attachment feature and the body relative to the other of the attachment feature and the body.

4. The system of claim 2, wherein coupling the vehicle component to the structure comprises inserting the attachment feature into a slot of the structure of the alignment fixture.

5. The system of claim 1, wherein the controller is configured to instruct the structure to move the one of the attachment feature of the vehicle component and the body of the vehicle component relative to the other of the attachment feature of the vehicle component and the body of the vehicle component.

6. The system of claim 5, wherein the at least one robot supports the vehicle component as the structure moves the one of the attachment feature and the body relative to the other of the attachment feature and the body.

7. The system of claim 5, wherein the structure comprises a gripper assembly including a pair of opposed grippers.

8. The system of claim 1, further comprising the vehicle component, the vehicle component comprising a first electrical feature that is automatically electrically coupled to a second electrical feature of the vehicle when the vehicle component is secured to the vehicle.

9. The system of claim 8, wherein the first electrical feature comprises pogo pins.

10. The system of claim 8, wherein the attachment feature includes an attachment structure, and wherein the attachment structure secures the attachment feature to the body of the vehicle via a snap fit.

11. The system of claim 8, wherein the vehicle component is a sun visor.

12. A system for installing a vehicle component into a vehicle, the system comprising:
a first robot;
a second robot; and
a controller in communication with the first robot and the second robot, the controller configured to:
instruct the first robot to grasp the vehicle component and move the vehicle component to a structure of an alignment fixture;
instruct one of the structure and the first robot to move one of an attachment feature of the vehicle component and a body of the vehicle component relative to the other of the attachment feature of the vehicle component and the body of the vehicle component;
instruct the second robot to move the vehicle component from the structure to the vehicle; and
instruct the second robot to insert the attachment feature of the vehicle component into an opening in a body of the vehicle until the vehicle component is secured to the body of the vehicle.

13. The system of claim 12, wherein the controller is configured to instruct the first robot to move the one of the attachment feature of the vehicle component and the body of the vehicle component relative to the other of the attachment feature of the vehicle component and the body of the vehicle component.

14. The system of claim 13, wherein the controller is configured to instruct the first robot to couple the vehicle component to the structure of the alignment fixture before moving the one of the attachment feature and the body relative to the other of the attachment feature and the body.

15. The system of claim 12, wherein the controller is configured to instruct the structure to move the one of the attachment feature of the vehicle component and the body of the vehicle component relative to the other of the attachment feature of the vehicle component and the body of the vehicle component.

16. The system of claim 12, further comprising the vehicle component, the vehicle component comprising a first electrical feature that is automatically electrically coupled to a second electrical feature of the vehicle when the vehicle component is secured to the vehicle.

17. The system of claim 16, wherein the first electrical feature comprises pogo pins.

18. The system of claim 16, wherein the attachment feature includes an attachment structure, and wherein the attachment structure secures the attachment feature to the body of the vehicle via a snap fit.

19. The system of claim 16, wherein the vehicle component is a sun visor.

20. A system for installing a vehicle component into a vehicle, the system comprising:
a first robot;
a second robot; and
a controller in communication with the first robot and the second robot, the controller configured to:
instruct the first robot to grasp the vehicle component and move the vehicle component to a first structure of an alignment fixture;
instruct the first structure to move an attachment feature of the vehicle component relative to a body of the vehicle component;
instruct the first robot to grasp the vehicle component and move the vehicle component from the first structure to a second structure of the alignment fixture;
instruct the first robot to move the body of the vehicle component relative to the attachment feature of the vehicle component at the second structure;
instruct the second robot to move the vehicle component from the second structure to the vehicle; and
instruct the second robot to insert the attachment feature of the vehicle component into an opening in a body of the vehicle until the vehicle component is secured to the body of the vehicle.
